(19) United States
(12) Patent Application Publication
(10) Pub. No.: US 2004/0183367 A1
(43) Pub. Date: Sep. 23, 2004

(54) Hydraulic brake apparatus for a vehicle

(76) Inventor: Akihito Kusano, Toyota city (JP)

Correspondence Address: BURNS DOANE SWECKER & MATHIS L L P, POST OFFICE BOX 1404, ALEXANDRIA, VA, 22313-1404, US

(21) Appl. No.: 10/801,649

(22) Filed: Mar. 17, 2004

(30) Foreign Application Priority Data
Mar. 18, 2003 (JP) 2003-074187

(51) Int. Cl. B60T 13/18

(52) U.S. Cl. 303/11

(57) ABSTRACT

The present invention is directed to a hydraulic brake apparatus provided with a pressure source for generating hydraulic pressure, a pressure regulating valve for regulating the hydraulic pressure generated by the pressure source in response to an input state, a master cylinder having a master piston for defining a pressure chamber for receiving therein the hydraulic pressure fed from the pressure regulating valve, and a master chamber for discharging hydraulic braking pressure. And, a pressure supply device is provided for supplying the hydraulic pressure from the pressure chamber into a hydraulic pressure circuit including the master cylinder and the wheel brake cylinder, when the hydraulic braking pressure discharged from the master cylinder is equal to or greater than a first predetermined pressure, and/or when the hydraulic pressure in the pressure chamber is equal to or greater than a second predetermined pressure. The pressure supply device may include a switching valve with one port thereof connected to the pressure chamber, and the other one port connected to a passage between the master cylinder and the wheel brake cylinder.

This application claims priority under 35 U.S.C. Sec.119 to No. 2003-074187 filed in Japan on Mar. 18, 2003, the entire content of which is herein incorporated by reference.

### BACKGROUND OF THE INVENTION

1. Field of the invention

The present invention relates to a hydraulic brake apparatus for supplying hydraulic brake pressure to each wheel brake cylinder operatively mounted on each wheel of a vehicle, and more particularly to the apparatus for supplying the hydraulic pressure-from a pressure regulating valve into a pressure chamber of a master cylinder, to advance a master piston by the hydraulic pressure in the pressure chamber.

2. Description of the Related Arts

Heretofore, there is known a hydraulic brake apparatus which is provided with a pressure regulating valve for regulating the hydraulic pressure of a hydraulic pressure source in response to braking operation of a vehicle driver, and adapted to supply the hydraulic pressure from the pressure regulating valve into a pressure chamber of a master cylinder, to advance a master piston by the hydraulic pressure in the pressure chamber. For example, a hydraulic brake booster is disclosed in the U.S. Pat. No. 4,126,996, which corresponds to Japanese Patent publication for opposition No.61-37140. In this patent, it is described that the brake booster includes a booster piston which defines a storage pressure chamber and the dual-circuit main cylinder includes a dual piston which defines a primary pressure chamber. And, it is described that a separating wall is provided which is connected to both the booster cylinder and the dual-circuit main cylinder and separates the storage pressure chamber from the primary pressure chamber, as disclosed in FIG. 1 of the patent.

According to the hydraulic brake apparatus for supplying the hydraulic pressure from the pressure regulating valve into the pressure chamber of the master cylinder, to advance the master piston by the hydraulic pressure in the pressure chamber, as described before, a sufficiently large capacity has to be provided for the master chamber, so that it is difficult to reduce the size of the apparatus. Therefore, it has been proposed to form the pressure regulating valve separately from the apparatus and provide it in parallel with the master cylinder, so as to reduce its length in the axial direction, for example. However, it is still difficult to reduce the size of the apparatus as a whole. Particularly, the dual piston and booster piston are aligned on a common axis, so that the total length of the booster is necessarily made large, also due to its structural difficulties. Consequently, it is difficult to install it in a vehicle.

### SUMMARY OF THE INVENTION

Accordingly, it is an object of the present invention to provide a hydraulic brake apparatus for a vehicle, which is provided with a pressure regulating valve for regulating the hydraulic pressure of a hydraulic pressure source in response to braking operation of a vehicle driver, and adapted to supply the hydraulic pressure from the pressure regulating valve into a pressure chamber of a master cylinder, to advance a master piston by the hydraulic pressure in the pressure chamber, and which is capable of supplying the hydraulic pressure from the pressure chamber into a hydraulic pressure circuit including the master cylinder, appropriately in response to braking operation, so as to minimize the apparatus as a whole.

In order to accomplish the above and other objects, the hydraulic brake apparatus is provided with a pressure source for generating hydraulic pressure, a pressure regulating valve for regulating the hydraulic pressure generated by the pressure source in response to braking operation of a vehicle driver, a master cylinder for introducing the hydraulic pressure from said pressure regulating valve into a pressure chamber, and advancing a master piston by the hydraulic pressure in said pressure chamber to discharge hydraulic braking pressure from a master chamber, and a wheel brake cylinder operatively mounted on each wheel of the vehicle for applying braking force to the wheel with the hydraulic braking pressure discharged from the master cylinder. And, a pressure supply device is provided for supplying the hydraulic pressure from the pressure chamber into a hydraulic pressure circuit including the master cylinder and the wheel brake cylinder, when the hydraulic braking pressure discharged from the master cylinder is equal to or greater than the first predetermined pressure, and/or when the hydraulic pressure in the pressure chamber is equal to or greater than the second predetermined pressure.

In the hydraulic brake apparatus as described above, the pressure supply device preferably begins to supply the hydraulic pressure from the pressure chamber into the hydraulic pressure circuit, when the hydraulic braking pressure discharged from the master cylinder is equal to or greater than the first predetermined pressure, and/or when the hydraulic pressure in the pressure chamber is equal to or greater than the second predetermined pressure, and the pressure supply device terminates supplying the hydraulic pressure from the pressure chamber into the hydraulic pressure circuit, when the hydraulic braking pressure discharged from the master cylinder and/or the hydraulic pressure in the pressure chamber is equal to or lower than a third predetermined pressure. The third predetermined pressure may be set to be zero.

In the hydraulic brake apparatus as described above, the pressure supply device may begin to supply the hydraulic pressure from the pressure chamber into the hydraulic pressure circuit, when the hydraulic braking pressure discharged from the master cylinder is equal to or greater than the first predetermined pressure, and/or when the hydraulic pressure in the pressure chamber is equal to or greater than the second predetermined pressure, and may terminate supplying the hydraulic pressure from the pressure chamber into the hydraulic pressure circuit, when a predetermined time has elapsed from the beginning of supplying the hydraulic pressure from the pressure chamber into the hydraulic pressure circuit.

In the hydraulic brake apparatus as described above, the first predetermined pressure may be set to be equal to the second predetermined pressure.

The pressure supply device may include a switching valve with one port thereof connected to the pressure chamber, and the other one port connected to a passage between the master cylinder and the wheel brake cylinder. And, the switching valve is opened, when the hydraulic pressure is supplied from the pressure chamber into the hydraulic pressure circuit.

The hydraulic brake apparatus as described above may further include a normally open first switching valve with one port thereof connected to a reservoir for storing brake fluid fed to the master cylinder and the other one port connected to the master chamber, and the pressure supply device may include a normally closed second switching valve with one port thereof connected to the pressure chamber and the other one port connected to a passage between the first switching valve and the master chamber, so that the first switching valve is closed and the second switching valve is opened, when the hydraulic pressure is supplied from the pressure chamber into the hydraulic pressure circuit. Those switching valves may be made of a solenoid operated switching valve, or made of a pressure responsive valve which can be actuated by the hydraulic braking pressure discharged from the master cylinder.

The hydraulic brake apparatus as described above may further include a pressure detecting device for detecting at least one of the hydraulic braking pressure discharged from the master cylinder and the hydraulic pressure in the pressure chamber, so that the pressure supply device controls the hydraulic pressure in the pressure chamber supplied into the hydraulic pressure circuit, on the basis of the pressure detected by the pressure detecting device.

### BRIEF DESCRIPTION OF THE DRAWINGS

The above stated object,and following description will become readily apparent with reference to the accompanying drawings, wherein like reference numerals denote like elements, and in which:

FIG. 1 is a sectional view of a hydraulic brake apparatus according to an embodiment of the present invention;

FIG. 2 is a sectional view of a hydraulic brake apparatus according to another embodiment of the present invention;

FIG. 3 is a flowchart showing an example of operation of a hydraulic brake apparatus according to an embodiment of the present invention;

FIG. 4 is a flowchart showing another example of operation of a hydraulic brake apparatus according to an embodiment of the present invention;

FIG. 5 is a flowchart showing an example of operation of a hydraulic brake apparatus according to another embodiment of the present invention; and

FIG. 6 is a flowchart showing another example of operation of a hydraulic brake apparatus according to another embodiment of the present invention.

### DESCRIPTION OF THE PREFERRED EMBODIMENTS

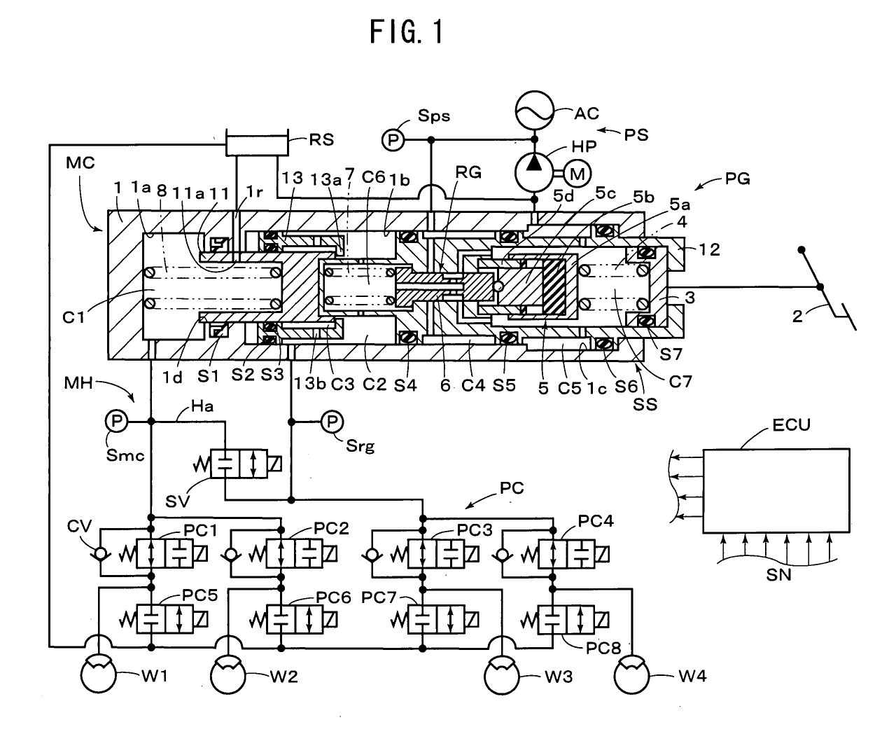

Referring to FIG. 1, there is illustrated a hydraulic brake apparatus for a vehicle according to an embodiment of the present invention, which includes a pressure generator PG for generating hydraulic pressure in response to operation of a brake pedal 2, i.e., braking operation by a vehicle driver. The apparatus includes wheel brake cylinders W1-W4, each of which is operatively mounted on each wheel of the vehicle, to apply braking force to the wheel with the hydraulic pressure fed from the pressure generator PG. And, a pressure control valve device PC is disposed between the pressure generator PG and the wheel brake cylinders W1-W4.

According to the present embodiment, the pressure generator PG is provided with a pressure source PS for generating a certain hydraulic pressure irrespective of operation of the brake pedal 2, a pressure regulating valve RG for regulating the hydraulic pressure generated by the pressure source PS in response to braking operation by a vehicle driver, and a master cylinder MC for introducing the hydraulic pressure from the pressure regulating valve RG into a pressure chamber C2, and advancing a master piston 11 by the hydraulic pressure in the pressure chamber C2 to discharge hydraulic braking pressure from a master chamber C1. The master piston 11 is advanced by the hydraulic pressure in the pressure chamber C2 to discharge the hydraulic braking pressure from the master chamber C1. The pressure source PS includes an electric motor M controlled by an electronic control unit ECU, and a hydraulic pressure pump HP, which is driven by the electric motor M, and whose inlet is connected to a reservoir under atmospheric pressure RS (hereinafter, simply referred to as a reservoir RS), and whose outlet is connected to an accumulator AC. According to the present embodiment, a pressure sensor Sps is connected to the outlet, and the detected pressure is monitored by the electronic control unit ECU. On the basis of the monitored result, the motor M is controlled by the electronic control unit ECU to keep the hydraulic pressure in the accumulator AC between predetermined upper and lower limits.

In a cylinder 1 which serves as a body portion of the pressure generator PG, there is formed a stepped bore which includes bores 1a, 1b, 1c and 1d having different inner diameters from one another, and in which a master piston 11 and an auxiliary piston 12 are received. In the auxiliary piston 12, there are accommodated a pressure regulating valve RG and a distribution device 5, which will be described later in detail. Furthermore, a cylindrical rear motion restricting member 13 is received in the cylinder 1. Although the cylinder 1 is illustrated as one body in FIG. 1 to be understood easily, it is formed with a plurality of cylindrical members assembled together in practice. In the inner surface of the bore 1d of cylinder 1, there is disposed an annular cup-like seal member S1, into which the master piston 11 in the shape of a cylinder with a bottom is fluid-tightly and slidably fitted. The auxiliary piston 12 has a plurality of land portions, which are formed around its outer surface, and on which a plurality of seal members S4-S6 are disposed, respectively. And, the auxiliary piston 12 is slidably fitted into the bore 1b through seal members S4 and S5, and in a bore 1c with a larger diameter than that of the bore 1b through a seal member S6, respectively. Thus, the auxiliary piston 12 is accommodated in the stepped cylinder bore as described above, and normally biased rearward because of the pressure relationship as explained later, to be held in its initial position as shown in FIG. 1. Then, if the pressure source PS is failed to discharge the hydraulic pressure, the auxiliary piston 12 is released from being held rearward, so that it comes to be in a state capable of being moved forward. Furthermore, a front end of the rear motion restricting member 13 is slidably received between the inner peripheral surface of the pressure chamber C2 and the outer peripheral surface of the master piston 11 through the seal members S2 and S3. An engaging portion 13a is formed at a rear end of the rear motion restricting member 13, so that the engaging portion 13a is engaged with a shoulder portion formed at the rear end.

As shown in FIG. 1, a master chamber C1 is defined in the bore 1a of the cylinder 1 between the master piston 11 at the seal member S1 and the front end of the cylinder 1, and a pressure chamber C2 is defined in the bore 1b between the rear motion restricting member 13 at the seal member S2 and the auxiliary piston 12 at the seal member S3. Between the inner surface of the rear motion restricting member 13 and the outer surface of the master piston 11, there is defined an annular chamber C3, which is communicated with the pressure chamber C2 through a communication passage 13b. In FIG. 1, the front of the cylinder 1 is directed to the left. Thus, the master cylinder MC is formed in the front section of the cylinder 1. Furthermore, an annular chamber C4 is defined between the seal member S4 and the seal member S5, and an annular chamber C5 is defined between the seal member S5 and the seal member S6, respectively.

In the auxiliary piston 12, there is accommodated a spool valve mechanism which serves as the pressure regulating valve RG according to the present embodiment. In front of a spool 6, a regulated pressure chamber C6 is defined to communicate with the pressure chamber C2, and a low pressure chamber C7 is defined at the rear of the spool 6 to communicate with the annular chamber C5. An input piston 3 is fluid-tightly and slidably fitted into the auxiliary piston 12, so that the low pressure chamber C7 is defined in front of the input piston 3. Within the low pressure chamber C7, there are accommodated the distribution device 5 and a compression spring 4 for transmitting the braking operation force applied to the input piston 3 and providing a stroke for the input piston 3 in response to the braking operation force.

The distribution device 5 is provided for adjusting the relationship between the braking operation force applied to the brake pedal 2 and the hydraulic pressure discharged from the pressure regulating valve RG. It includes a cylindrical member 5d with its front end abutting on the front end face of the auxiliary piston 12 in the low pressure chamber C7, and with its rear end mounting a plastic ring member thereon, a case 5a formed in the shape of a cylinder with a bottom, for slidably receiving therein the cylindrical member 5d, a rubber disc 5b disposed between the case 5a and the cylindrical member 5d, and a transmitting member 5c with a steel ball mounted on its front end. According to the distribution device 5, when the brake pedal 2 is depressed, the braking force is transmitted to the spool 6 through the input piston 3, compression spring 4, case 5a, rubber disc 5b and transmitting member 5c, so that the pressure regulating valve RG is operated to output the hydraulic pressure exerted in the regulated pressure chamber C6, from the pressure chamber C2. When the braking operation force exceeds a predetermined value, the elastically deformed rubber disc 5b abuts on the plastic ring member mounted on the cylindrical member 5d, so that a part of the braking operation force is distributed to be transmitted to the auxiliary piston 12 through the rubber disk 5b. According to the present embodiment, therefore, can be given a jumping property which provides a steep rise of pressure in the beginning of the braking operation. Also, with the inner diameter of the cylindrical member 5d and the outer diameter of the transmitting member 5c varied, a distribution ratio of the braking operation to be transmitted to the spool 6 can be varied. Furthermore, with the length of the transmitting member 5c varied, a starting time for the distribution of the braking operation can be varied. Therefore, by combining the cylindrical member 5d and transmitting member 5c of different dimensions appropriately, the output property of the pressure regulating valve RG in response to the braking operation force can be provided as required. The distribution device 5 may be omitted, instead, it may be so constituted as to transmit the braking operation force directly to the spool 6.

As for the pressure regulating valve RG of the present embodiment, the compression spring 7 which acts as a return spring is accommodated in the regulated pressure chamber C6 to press the spool 6 rearward by its biasing force. The load for mounting the compression spring 7 is set to be larger than the load for mounting the compression spring 4, so that when the brake pedal 2 is not depressed, the state as shown in FIG. 1 is maintained. The low pressure chamber C7 is connected to the reservoir RS together with the inlet of the pressure source PS, through the annular chamber C5, so that the annular chamber C5 and low pressure chamber C7 are filled with the brake fluid under approximately atmospheric pressure in the reservoir RS. The annular chamber C4 is connected to the accumulator AC of the pressure source PS, so that the hydraulic pressure discharged from the pressure source PS is supplied, to provide a relatively high pressure chamber.

Accordingly, when the spool 6 is placed at the rearmost initial position as shown in FIG. 1, the regulated pressure chamber C6 is communicated with the low pressure chamber C7 through the spool 6 to be under the atmospheric pressure as in the reservoir RS. When the input piston 3 is moved forward, and then the spool 6 is moved forward to block the communication between the regulated pressure chamber C6 and the low pressure chamber C7, the pressure in the regulated pressure chamber C6 will be held. When the spool 6 is moved forward further, the regulated pressure chamber C6 is communicated with the pressure source PS through the spool 6, auxiliary piston 12 and annular chamber C4, so that the hydraulic pressure discharged from the pressure source PS is fed into the regulated pressure chamber C6 to increase the hydraulic pressure therein, thereby to provide a pressure increasing state. Thus, in accordance with a repetition of relative movement of the spool 6 to the auxiliary piston 12, the hydraulic pressure in the regulated pressure chamber C6 is regulated into a predetermined pressure, and discharged to the pressure chamber C2, and also discharged to the wheel brake cylinders W3 and W4 thorough switching solenoid valves (hereinafter, simply referred to as switching valves) PC3 and PC4, as will be described later.

In the master chamber C1, there is accommodated a compression spring 8 which acts as a return spring, and which forces the rear end surface of the master piston 11 to abut on the front end surface of the auxiliary piston 12. In other words, when the master piston 11 is placed at its rearmost initial position, a communication hole 11a defined on a skirt portion of the master piston 11 is communicated with a communication hole 1r defined on a cylinder 1, so that the master chamber C1 is under approximately atmospheric pressure as in the reservoir RS. When the master piston 11 is moved forward, the communication hole 11a will be closed by the seal member S1, to block its communication with the reservoir RS. Therefore, when the master piston 11 in this state is further moved forward, the hydraulic pressure in the master chamber C1 will be increased.

When the brake pedal 2 is depressed to generate the hydraulic pressure in the master chamber C1 and pressure chamber C2, so that no pressure difference is caused between them, then the rear motion restricting member 13 is pressed onto the front end of the pressure chamber C2, with a force produced on the basis of a difference in effective pressure responsive area between the rear motion restricting member 13 and the master piston 11, to restrict the master piston 11 from being moved rearward. At this position, as the communication between the hole 11a and hole 1r is blocked by the seal member S1, so that the communication between the master chamber C1 and the reservoir RS is held to be blocked. And, if the brake pedal 2 is released to reduce the pressure in the pressure chamber C2, for example, the rear motion restricting member 13 is returned by the biasing force of the compression spring 8 to its initial position as shown in FIG. 1, together with the master piston 11.

As shown in FIG. 1, according to the present embodiment, the wheel brake cylinders W1 and W2 operatively mounted on the front wheels are connected to the master chamber C1 through the switching valves PC1 and PC2, respectively. On the contrary, the wheel brake cylinders W3 and W4 operatively mounted on the rear wheels are connected to the pressure chamber C2 (then to the regulated pressure chamber C6) through the switching valves PC3 and PC4. Consequently, the hydraulic pressure output from the regulated pressure chamber C6 is supplied to the wheel brake cylinders W3 and W4 through the switching valves PC3 and PC4 placed in their open positions. Also, the hydraulic pressure output from the regulated pressure chamber C6 is supplied to the pressure chamber C2, to advance the master piston 11, so that the hydraulic pressure output from the master chamber C1 is supplied to the wheel brake cylinders W1 and W2 through the switching valves PC1 and PC2 placed in their open positions.

According to the present embodiment, a pressure sensor Smc is disposed in a hydraulic passage connected to the master chamber C1 at the output side thereof, and a pressure sensor Srg is disposed in a hydraulic passage connected to the pressure chamber C2 (and, regulated pressure chamber C6) at the output side thereof, and signals detected by the sensors Smc and Srg are fed to the electronic control unit ECU. Thus, the hydraulic braking pressure discharged from the master chamber C1 and the hydraulic pressure output from the pressure chamber C2 are monitored and provided for the controls as described later. Furthermore, in order to achieve those controls including an anti-skid control or the like, sensors (indicated by “SN” in FIG. 1) such as wheel speed sensors, acceleration sensor or the like have been provided, so that the signals detected by them are fed to the electronic control unit ECU.

Furthermore, according to the present embodiment, the pressure control valve device PC is constituted by the switching valves PC1-PC8 and etc. as shown in FIG. 1, to control the hydraulic braking pressure (wheel brake cylinder pressure) in the anti-skid control, for example. As shown in FIG. 1, the switching valves PC1 and PC5, and the switching valves PC2 and PC6, for use in the control of supplying and draining the hydraulic pressure respectively, are disposed in hydraulic pressure circuits connecting the master chamber C1 and the wheel brake cylinders W1 and W2 operatively mounted on the front wheels, respectively. Also, the switching valves PC3 and PC7, and the switching valves PC4 and PC8, for use in the control of supplying and draining the hydraulic pressure respectively, are disposed in hydraulic pressure circuits connecting the pressure chamber C2 and the wheel brake cylinders W3 and W4 operatively mounted on the rear wheels, respectively. The switching valves PC1-PC4 for supplying the hydraulic pressure are normally opened, while the switching valves PC5-PC8 for draining the hydraulic pressure are normally closed, and connected to the reservoir RS, respectively. In parallel with the switching valves PC1-PC4, a check valve CV is disposed, respectively, so that when the brake pedal 2 is released, the flow of brake fluid in the wheel brake cylinders W1-W4 to the master chamber C1 and pressure chamber C2 is allowed, respectively, whereas its reverse flow is blocked. In FIG. 1, the overall hydraulic system has been divided into a pressure control circuit for the front wheels and a pressure control circuit for the rear wheels to provide a front-rear circuit system. Instead, a so-called diagonal circuit system may be employed. The switching valves PC1 and PC5 may be assembled together with each check valve CV, to provide a changeover valve for use in the control of supplying and draining the hydraulic pressure.

Furthermore, it is so constituted that the hydraulic pressure in the pressure chamber C2 can be supplied to the hydraulic pressure circuit MH including the master cylinder MC and the wheel brake cylinders W1 and W2 (switching valves PC1 and PC2), through the switching valve SV. The switching valve SV serves as the pressure supply means of the present invention, together with the electronic control unit ECU. The switching valve SV is a normally closed two-port two-position solenoid operated switching valve. When the switching valve SV is de-energized, it is placed in its closed position as shown in FIG. 1, whereas it is placed in its open position to communicate the pressure chamber C2 with the master chamber C1 (and the switching valves PC1 and PC2), when it is energized. Therefore, it is so constituted that the hydraulic pressure is supplied from the pressure chamber C2 into the hydraulic pressure circuit MH including the master cylinder MC and the wheel brake cylinders W1 and W2 (switching valves PC1 and PC2), when the hydraulic braking pressure discharged from the master cylinder MC is equal to or greater than a first predetermined pressure P1, and when the hydraulic pressure in the pressure chamber C2 is equal to or greater than a second predetermined pressure P2 (equal to or greater than the first predetermined pressure P1).

In operation, according to the pressure generator PG of the hydraulic brake apparatus of the embodiment as constituted above, when the brake pedal 2 is not depressed, the input piston 3 and the spool 6 of the pressure regulating valve RG are in the state as shown in FIG. 1. In this state, the spool 6 has been pressed onto the auxiliary piston 12 by the biasing force of the compression spring 7, so that the communication between the regulated pressure chamber C6 and the annular chamber C4 is blocked, whereas the regulated pressure chamber C6 is communicated with the low pressure chamber C7 (i.e., the pressure decreasing state). Consequently, the regulated pressure chamber C6 has been communicated with the reservoir RS to be under approximately atmospheric pressure, the hydraulic pressure output from the regulated pressure chamber C6 is not supplied to the pressure chamber C2, so that the master piston 11 is held in its initial position as shown in FIG. 1.

When depressing force is applied to the brake pedal 2, the braking operation force is transmitted to the spool 6 through the input piston 3, compression spring 4 and distribution device 5, to advance the spool 6, with the compression spring 7 being compressed. When the brake pedal 2 is depressed further against the biasing force of the compression spring 7, and the spool 6 is placed at a position where the regulated pressure chamber C6 does not communicate with the annular chamber C4, nor the low pressure chamber C7, the pressure holding state is provided. When further depressing force is applied to the brake pedal 2 to advance the spool 6, the regulated pressure chamber C6 will communicate with the annular chamber C4, with the communication between the regulated pressure chamber C6 and the low pressure chamber C7 being blocked, so that the regulated pressure chamber C6 will communicate with the annular chamber C4, to supply the hydraulic pressure output from the pressure source PS to the regulated pressure chamber C6 through the annular chamber C4. As a result, the pressure increasing state is provided.

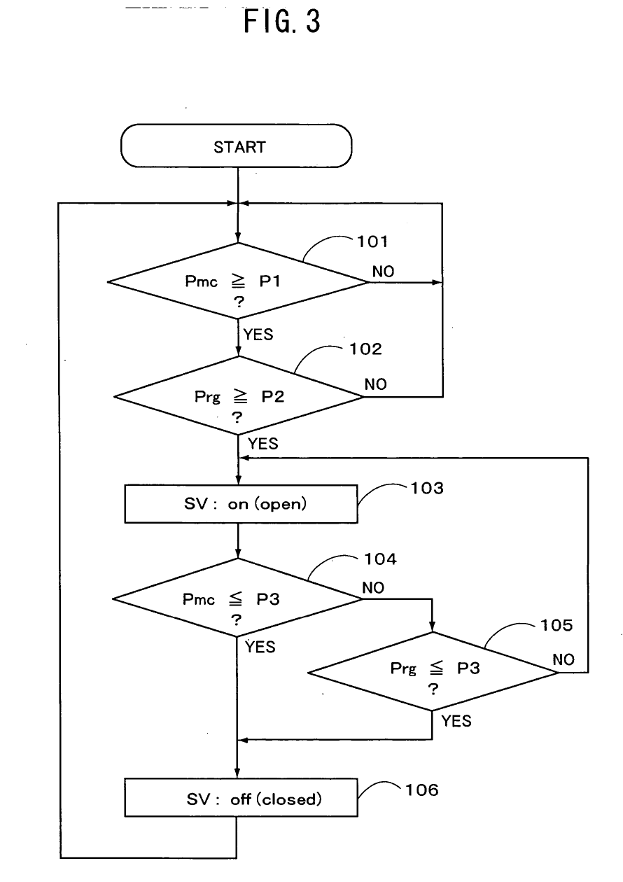

Therefore, if the brake pedal 2 is operated in the pressure decreasing state as shown in FIG. 1, the hydraulic pressure in the regulated pressure chamber C6 is regulated into the hydraulic pressure determined in response to the force transmitted from the input piston 3 to the spool 6 through the compression spring 4 and distribution device 5, by the pressure regulating valve RG, then the regulated pressure is supplied to the pressure chamber C2, and supplied to the wheel brake cylinders W3 and W4 through the switching valves PC3 and PC4 placed in their open positions, and at the same time the master piston 11 is actuated with the regulated pressure. Consequently, the hydraulic pressure determined in response to the braking operation force is supplied from the master chamber C1 to the wheel brake cylinders W1 and W2 through the switching valves PC1 and PC2 placed in their open positions. And, when the hydraulic braking pressure discharged from the master chamber C1 is equal to or greater than the first predetermined pressure P1, and when the hydraulic pressure in the pressure chamber C2 is equal to or greater than the second predetermined pressure P2 (equal to or greater than the first predetermined pressure P1), the switching valves SV is controlled to be opened and closed, as will be explained later with reference to FIG. 3.

Furthermore, according to the present embodiment, the switching valves PC1-PC8 are controlled by the electronic control unit ECU, to open or close the switching valves PC1-PC8, thereby to control the hydraulic braking pressure in each wheel brake cylinder to be rapidly increased, gradually increased (pulse increase mode), gradually decreased (pulse decrease mode), rapidly decreased, or held, in response to the signals detected by each sensor SN, so that the hydraulic pressure control required for the anti-skid control can be made. In this respect, the hydraulic pressure control as described above is not directly related to the present invention, so that explanation of its operation is omitted herein.

Then, if the pressure source PS is failed during the operation of the pressure generator PG, the hydraulic pressure is not discharged from the pressure source PS to the annular chamber C4. In this case, therefore, when the input piston 3 is advanced in response to operation of the brake pedal 2, the spool 6 is advanced against the biasing force of the compression spring 7, and the input piston 3 is advanced against the biasing force of the compression spring 4, so that the force applied to the brake pedal 2 is transmitted to the auxiliary piston 12 through the distribution device 5, and further transmitted to the master piston 11, whereby the hydraulic braking pressure is supplied from the master chamber C1 to the wheel brake cylinders W1 and W2.

According to the present embodiment, the switching valve SV is controlled by the electronic control unit ECU, as shown in FIG. 3. At the outset, the pressure Pmc detected by the pressure sensor Smc, which corresponds to the hydraulic braking pressure discharged from the master chamber C1, is compared with the first predetermined pressure P1 at Step 101. The first predetermined pressure P1 is set to be 6.5 MPa, for example. When it is determined that the pressure Pmc detected by the pressure sensor Smc is equal to or greater than the first predetermined pressure P1, the program further proceeds to Step 102, where the pressure Prg detected by the pressure sensor Srg, which corresponds to the hydraulic pressure output from the pressure chamber C2, is compared with the second predetermined pressure P2. The second predetermined pressure P2 is set to be 6.7 MPa, for example, but it may be set to be the same pressure value as the first predetermined pressure P1. When it is determined that the pressure Prg detected by the pressure sensor Srg is equal to or greater than the second predetermined pressure P2, the program proceeds to Step 103, where the switching valve SV is energized (turned on), to be placed in its open position.

According to the present embodiment, therefore, when it is determined at Step 101 that the pressure Pmc detected by the pressure sensor Smc is lower than the first predetermined pressure P1, and/or when it is determined at Step 102 that the pressure Prg detected by the pressure sensor Srg is lower than the second predetermined pressure P2, the program will not further proceed to Step 103, but may wait until both of the pressure Pmc and pressure Prg will be equal to or greater than the first and second predetermined pressures P1 and P2, respectively. Instead, it may be so constituted that when either one condition of those as determined at Steps 101 and 102 is fulfilled, the program may further proceed to Step 103. Accordingly, the switching valve SV is placed in its open position at Step 103, whereby the hydraulic pressure in the pressure chamber C2 is supplied to the hydraulic pressure circuit MH including the master cylinder MC and the wheel brake cylinders W1 and W2, so that appropriate hydraulic braking pressure can be supplied to the wheel brake cylinders W1 and W2. When the braking operation is terminated, for example, to result in reduction of the hydraulic braking pressure discharged from the master cylinder MC, the program proceeds to Step 104, where the pressure Pmc detected by the pressure sensor Smc is compared with a third predetermined pressure P3. As a result, if it is determined that the pressure Pmc detected by the pressure sensor Smc is equal to or lower than the third predetermined pressure P3, the program proceeds to Step 106, where the switching valve SV is de-energized (turned off), to be placed in its closed position. The third predetermined pressure P3 is set to be 5.5 MPa, for example, but it may be set to be zero. In the latter case, the hydraulic pressure will be supplied from the pressure chamber C2 to the hydraulic pressure circuit MH, until the braking operation is released.

At Step 104, if it is determined that the pressure Pmc detected by the pressure sensor Smc has exceeded the third predetermined pressure P3, the program proceeds to Step 105, where the pressure Prg detected by the pressure sensor Srg is compared with the third predetermined pressure P3. If it is determined that the detected pressure Pmc is equal to or lower than the third predetermined pressure P3, the program proceeds to Step 106, where the switching valve SV is held in its closed position. Thus, when at least one of the pressure detected by the pressure sensor Smc and the pressure detected by the pressure sensor Srg is equal to or lower than the third predetermined pressure P3, the switching valve SV is placed in its closed position, to terminate supplying the hydraulic pressure from the pressure chamber C2 to the wheel brake cylinders W1 and W2. Then, the wheel brake cylinders W1 and W2 will be communicated with the master cylinder MC.

Accordingly, if it is determined that the detected pressure Pmc is equal to or greater than the first predetermined pressure P1, and that the detected pressure Prg is equal to or greater than the second predetermined pressure P2, the hydraulic pressure in the pressure chamber C2 will be supplied to the hydraulic pressure circuit MH including the master cylinder MC and the wheel brake cylinders W1 and W2, so that the appropriate hydraulic braking pressure can be supplied to the wheel brake cylinders W1 and W2. Therefore, the master chamber C1 may be of a volume enough for receiving therein the brake fluid until the detected pressure Pmc will be equal to or greater than the first predetermined pressure P1 (and/or, the detected pressure Prg will be equal to or greater than the second predetermined pressure P2). As a result, a portion for constituting the master cylinder MC can be minimized, so that the hydraulic braking apparatus can be reduced in size as a whole. When it is determined that the detected pressure Pmc is equal to or lower than the third predetermined pressure P3, the switching valve SV is placed in its closed position to terminate supplying the hydraulic pressure from the pressure chamber C2 into the hydraulic pressure circuit MH. In this case, because the terminating reference (third predetermined pressure P3) and starting references (first and second predetermined pressures P1 and P2) are different in pressure from each other, the hydraulic pressure control can be terminated smoothly, without any hunting caused.

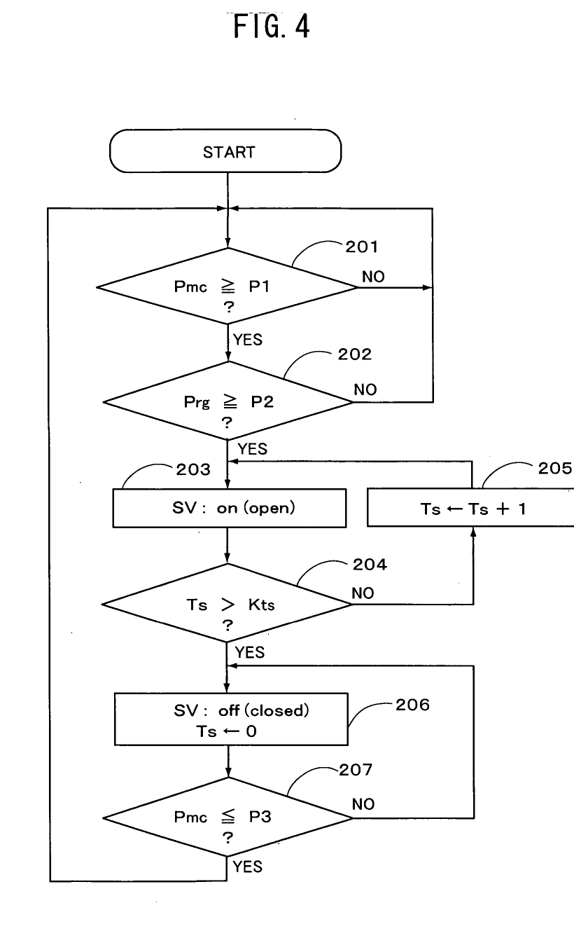

Instead of controlling the switching valve SV (shown in FIG. 1) as described above, the switching valve SV may be controlled as shown in FIG. 4. Although Steps 201-203 as shown in FIG. 4 are substantially the same as the Steps 101-103, after the switching valve SV was placed in its open position at Step 203, a time (i.e., period, TS) elapsed from the beginning of supplying the hydraulic pressure from the pressure chamber C2 into the hydraulic pressure circuit MH is measured. Then, at Step 204, the elapsed time Ts (i.e., the period after the beginning of supplying the hydraulic pressure from the pressure chamber C2 into the hydraulic pressure circuit MH) is compared with a predetermined time Kts. If the elapsed time Ts is equal to or shorter than the predetermined time Kts, it is incremented to provide a time (Ts+1) at Step 205, and then the program returns to Step 203, where the switching valve SV is held in its open position. If the elapsed time Ts exceeds the predetermined time Kts, the program proceeds from Step 204 to Step 206, where the switching valve SV is de-energized (turned off) to be placed in its closed position, and where the elapsed time Ts is cleared to be zero. Thus, when the elapsed time Ts has exceeded the predetermined time Kts after the beginning of supplying the hydraulic pressure from the pressure chamber C2 into the hydraulic pressure circuit MH, the operation for supplying the hydraulic pressure from the pressure chamber C2 into the hydraulic pressure circuit MH is terminated. In this case, the master piston 11 has been returned by the biasing force of the compression spring 8 to a position where it abuts on the rear motion restricting member 13, a volume enough for supplying the hydraulic pressure to the wheel brake cylinders W1 and W2 can be stored in the master chamber C1.

Then, the program proceeds to Step 207, where the pressure Pmc detected by the pressure sensor Smc is compared with the third predetermined pressure P3. If it is determined that the pressure Pmc has exceeded the third predetermined pressure P3, the program returns to Step 206, where the switching valve SV is held in its closed position. If it is determined that the pressure Pmc is equal to or lower than the third predetermined pressure P3, the program returns to Step 201 to repeat the operation as described above. With the hydraulic pressure controlled on the basis of the elapsed time Ts as described above, the operation for supplying the hydraulic pressure from the pressure chamber C2 is stopped during its operation. Therefore, the total time for energizing the switching valve SV can be reduced, comparing with the hydraulic pressure control as shown in FIG. 3.

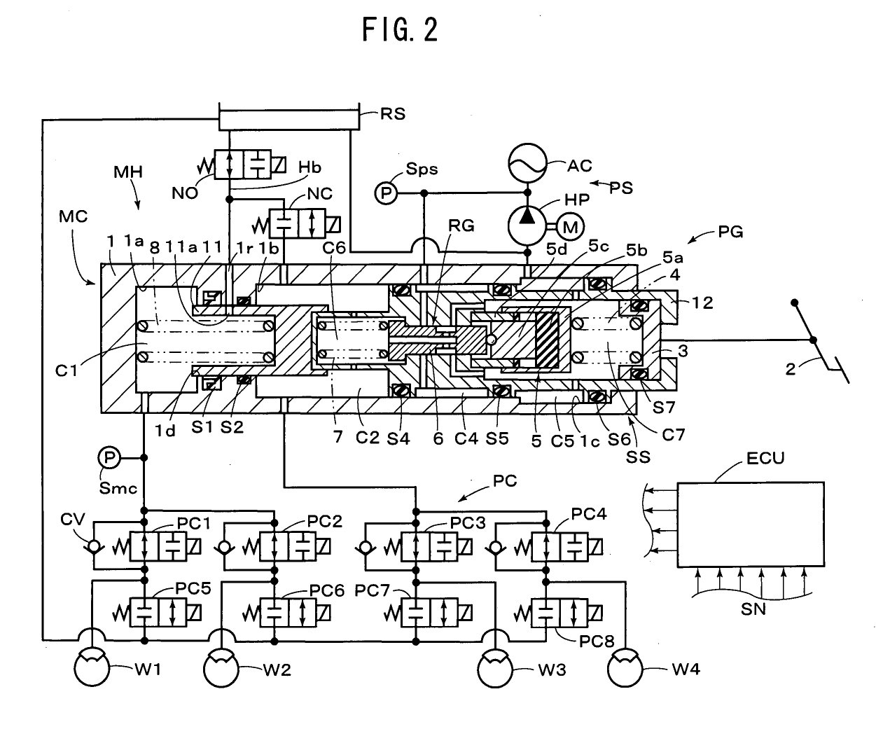

Next will be explained another embodiment of the present invention, with reference to FIG. 2, wherein a switching valve NO and a switching valve NC are provided, instead of the switching valve SV used in the embodiment as shown in FIG. 1, so that the rear motion restricting member 13 is omitted. In the present embodiment, the switching valve NO of a normally open two-port two-position solenoid operated switching valve is disposed on a hydraulic pressure passage Hb for communicating the master chamber C1 with the reservoir RS, and the switching valve NC of a normally closed two-port two-position solenoid operated switching valve is disposed on a hydraulic pressure passage for communicating the hydraulic pressure passage Hb with the pressure chamber C2. According to the present embodiment, therefore, the brake fluid is not fed from the master chamber C1 to the pressure chamber C2, even if the hydraulic pressure circuit including the pressure chamber C2 was failed during the braking operation, and the switching valves NO and NC were turned on. As a result, the pressure sensor Srg as shown in FIG. 1 can be omitted, because it is not required to monitor the hydraulic pressure in the pressure chamber C2. The switching valves NO and NC (and the switching valve SV in FIG. 1) may be substituted by pressure responsive valves actuated in response to the hydraulic braking pressure discharged from the master cylinder MC. As the remaining structure is substantially the same as the structure as shown in FIG. 1, its explanation is omitted herein, with the same reference numerals given to substantially the same elements as shown in FIG. 1.

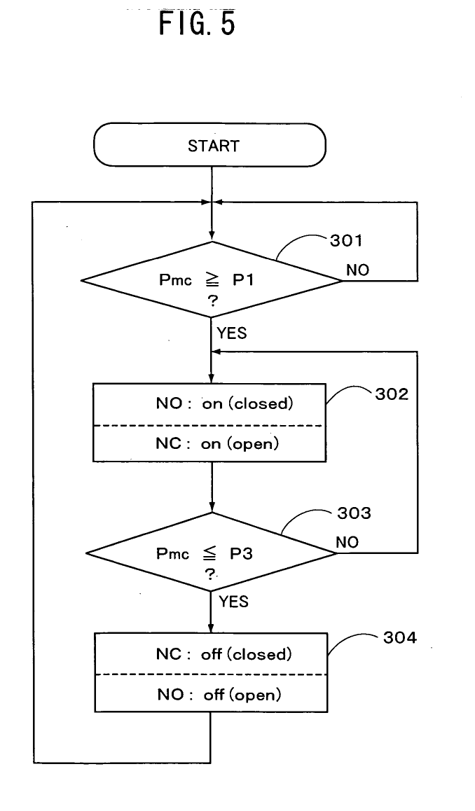

Accordingly, when the hydraulic pressure is to be supplied from the pressure chamber C2 to the hydraulic pressure circuit MH, the switching valve NO is placed in its closed position and the switching valve NC is placed in its open position, so that the hydraulic pressure control can be made in the same manner as the embodiment as shown in FIG. 1. According to the embodiment as shown in FIG. 2, the switching valves NO and NC are controlled by the electronic control unit ECU, as described hereinafter referring to FIG. 5. At the outset, the pressure Pmc detected by the pressure sensor Smc is compared with the first predetermined pressure P1 at Step 301. When it is determined that the pressure Pmc is equal to or greater than the first predetermined pressure P1, the program further proceeds to Step 302, where the switching valve NO is energized (turned on) to be placed in its closed position, and the switching valve NC is energized (turned on) to be placed in its open position. Consequently, the hydraulic pressure in the pressure chamber C2 will be supplied to the hydraulic pressure circuit MH including the master cylinder MC and the wheel brake cylinders W1 and W2, so that the appropriate hydraulic braking pressure can be supplied to the wheel brake cylinders W1 and W2.

When the braking operation is terminated, for example, to result in reduction of the hydraulic braking pressure discharged from the master cylinder MC, the program proceeds to Step 303, where the pressure Pmc detected by the pressure sensor Smc is compared with the third predetermined pressure P3 (e.g., 0). As a result, if it is determined that the detected pressure Pmc is equal to or lower than the third predetermined pressure P3, the program proceeds to Step 304, where the switching valve NC is de-energized (turned off) to be placed in its closed position, and the switching valve NO is de-energized (turned off) to be placed in its open position. At Step 303, if it is determined that the pressure Pmc detected by the pressure sensor Smc has exceeded the third predetermined pressure P3, the program returns to Step 302, where the switching valve NO is held in its closed position and the switching valve NC is held in its open position.

Accordingly, if it is determined that the detected pressure Pmc is equal to or greater than the first predetermined pressure P1, the hydraulic pressure is supplied from the pressure chamber C2 to the hydraulic pressure circuit MH including the master cylinder MC and the wheel brake cylinders W1 and W2, so that the appropriate hydraulic braking pressure can be supplied to the wheel brake cylinders W1 and W2. Therefore, the master chamber C1 may be of a volume enough for receiving therein the brake fluid until the detected pressure Pmc will be equal to or greater than the first predetermined pressure P1. As a result, a portion for constituting the master cylinder MC can be minimized, so that the hydraulic braking apparatus can be reduced in size as a whole. When it is determined that the detected pressure Pmc is equal to or lower than the third predetermined pressure P3, it is terminated to supply the hydraulic pressure from the pressure chamber C2 into the hydraulic pressure circuit MH. In this case, because the terminating reference (third predetermined pressure P3) and starting reference (first predetermined pressure P1) are different in pressure from each other, the hydraulic pressure control can be terminated smoothly, without any hunting caused.

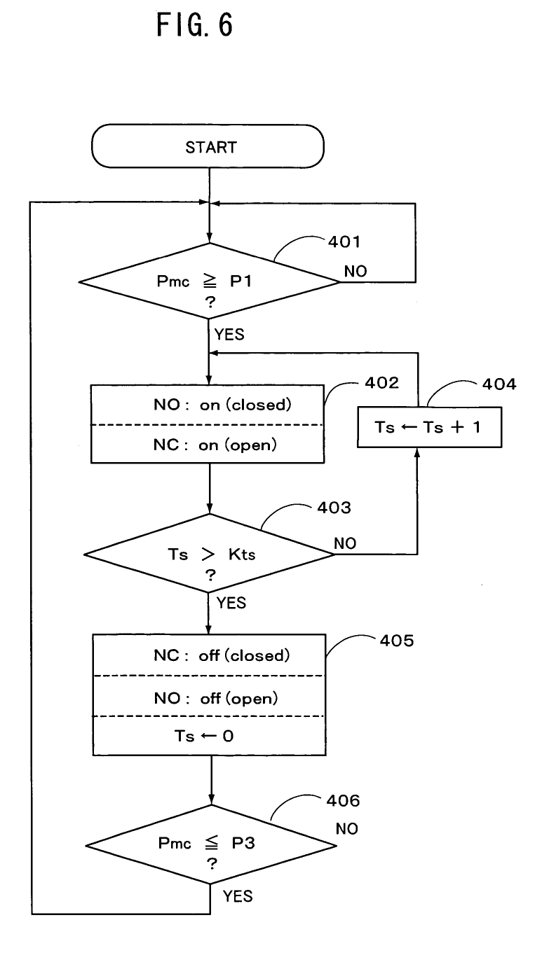

Instead of controlling the switching valves NC and NO as described in FIG. 2, they may be controlled as shown in FIG. 6. Steps 401 and 402 as shown in FIG. 6 are substantially the same as the Steps 301 and 302 as shown in FIG. 5. After the switching valve NO was placed in its closed position and the switching valve NC was placed in its open position, however, the time Ts elapsed from the beginning of supplying the hydraulic pressure from the pressure chamber C2 into the hydraulic pressure circuit MH is measured. Then, the elapsed time Ts (i.e., the period after the beginning of supplying the hydraulic pressure from the pressure chamber C2 into the hydraulic pressure circuit MH) is compared with a predetermined time Kts at Step 403. If the elapsed time Ts is equal to or shorter than the predetermined time Kts, it is incremented to provide a time (Ts+1) at Step 404, and then the program returns to Step 402, where the switching valve NO is held in its closed position and the switching valve NC is held in its open position.

If the elapsed time Ts exceeds the predetermined time Kts, the program proceeds from Step 403 to Step 405, where the switching valve NC is de-energized (turned off) to be placed in its closed position, and the switching valve NO is de-energized (turned off) to be placed in its open position, and where the elapsed time Ts is cleared to be zero. Thus, when the elapsed time Ts has exceeded the predetermined time Kts after the beginning of supplying the hydraulic pressure from the pressure chamber C2 into the hydraulic pressure circuit MH, the operation for supplying the hydraulic pressure from the pressure chamber C2 into the hydraulic pressure circuit MH is terminated. In this case, the master piston 11 is returned by the biasing force of the compression spring 8 to its initial position, and at the same time when the switching valves NC and NO are turned off, the master piston 11 is advanced to the position where the communication hole 11a is shut off with the seal member S1, whereby a volume enough for supplying the hydraulic braking pressure to the wheel brake cylinders W1 and W2 can be stored in the master chamber C1. Then, the program proceeds to Step 406, where the pressure Pmc detected by the pressure sensor Smc is compared with the third predetermined pressure P3. If it is determined that the detected pressure Pmc has exceeded the third predetermined pressure P3, the program returns to Step 405, where the switching valve NC is held in its closed position and the switching valve NO is held in its open position. If it is determined that the detected pressure Pmc is equal to or lower than the third predetermined pressure P3, the program returns to Step 401 to repeat the operation as described above. With the hydraulic pressure controlled on the basis of the elapsed time Ts as described above, the total time for energizing the switching valves NC and NO can be reduced, comparing with the hydraulic pressure control as shown in FIG. 5.

It should be apparent to one skilled in the art that the above-described embodiments are merely illustrative of but a few of the many possible specific embodiments of the present invention. Numerous and various other arrangements can be readily devised by those skilled in the art without departing from the spirit and scope of the invention as defined in the following claims.

What is claimed is:

1. A hydraulic brake apparatus for a vehicle comprising:
a pressure source for generating hydraulic pressure;
a pressure regulating valve for regulating the hydraulic pressure generated by said pressure source in response to braking operation by a vehicle driver;
a master cylinder for introducing the hydraulic pressure from said pressure regulating valve into a pressure chamber, and advancing a master piston by the hydraulic pressure in said pressure chamber to discharge hydraulic braking pressure from a master chamber;
a wheel brake cylinder operatively mounted on each wheel of said vehicle for applying braking force to said wheel with the hydraulic braking pressure discharged from said master cylinder; and
pressure supply means for supplying the hydraulic pressure from said pressure chamber into a hydraulic pressure circuit including said master cylinder and said wheel brake cylinder, when the hydraulic braking pressure discharged from said master cylinder is equal to or greater than a first predetermined pressure, and/or when the hydraulic pressure in said pressure chamber is equal to or greater than a second predetermined pressure.

2. A hydraulic brake apparatus as set forth in claim 1, wherein the first predetermined pressure is set to be equal to the second predetermined pressure.

3. A hydraulic brake apparatus as set forth in claim 1, wherein said pressure supply means includes a switching valve with one port thereof connected to said pressure chamber, and the other one port connected to a passage between said master cylinder and said wheel brake cylinder, and wherein said switching valve is opened, when the hydraulic pressure is supplied from said pressure chamber into said hydraulic pressure circuit.

4. A hydraulic brake apparatus as set forth in claim 1, wherein said pressure supply means begins to supply the hydraulic pressure from said pressure chamber into said hydraulic pressure circuit, when the hydraulic braking pressure discharged from said master cylinder is equal to or greater than the first predetermined pressure, and/or when the hydraulic pressure in said pressure chamber is equal to or greater than the second predetermined pressure, and said pressure supply means terminates supplying the hydraulic pressure from said pressure chamber into said hydraulic pressure circuit, when the hydraulic braking pressure discharged from said master cylinder and/or the hydraulic pressure in said pressure chamber is equal to or lower than a third predetermined pressure.

5. A hydraulic brake apparatus as set forth in claim 4, wherein the third predetermined pressure is set to be zero.

6. A hydraulic brake apparatus as set forth in claim 1, further comprising pressure detecting means for detecting at least one of the hydraulic braking pressure discharged from said master cylinder and the hydraulic pressure in said pressure chamber, and wherein said pressure supply means controls the hydraulic pressure in said pressure chamber supplied into said hydraulic pressure circuit, on the basis of the pressure detected by said pressure detecting means.

7. A hydraulic brake apparatus as set forth in claim 1, wherein said pressure supply means begins to supply the hydraulic pressure from said pressure chamber into said hydraulic pressure circuit, when the hydraulic braking pressure discharged from said master cylinder is equal to or greater than the first predetermined pressure, and/or when the hydraulic pressure in said pressure chamber is equal to or greater than the second predetermined pressure, and terminates supplying the hydraulic pressure from said pressure chamber into said hydraulic pressure circuit, when a predetermined time has elapsed from the beginning of supplying the hydraulic pressure from said pressure chamber into said hydraulic pressure circuit.

8. A hydraulic brake apparatus as set forth in claim 7, wherein the first predetermined pressure is set to be equal to the second predetermined pressure.

9. A hydraulic brake apparatus as set forth in claim 7, wherein said pressure supply means includes a switching valve with one port thereof connected to said pressure chamber, and the other one port connected to a passage between said master cylinder and said wheel brake cylinder, and wherein said switching valve is opened, when the hydraulic pressure is supplied from said pressure chamber into said hydraulic pressure circuit.

10. A hydraulic brake apparatus as set forth in claim 7, further comprising pressure detecting means for detecting at least one of the hydraulic braking pressure discharged from said master cylinder and the hydraulic pressure in said pressure chamber, and wherein said pressure supply means controls the hydraulic pressure in said pressure chamber supplied into said hydraulic pressure circuit, on the basis of the pressure detected by said pressure detecting means.

11. A hydraulic brake apparatus as set forth in claim 1, further comprising a normally open first switching valve with one port thereof connected to a reservoir for storing brake fluid fed to said master cylinder and the other one port connected to said master chamber, wherein said pressure supply means includes a normally closed second switching valve with one port thereof connected to said pressure chamber and the other one port connected to a passage between said first switching valve and said master chamber, and wherein said first switching valve is closed and said second switching valve is opened, when the hydraulic pressure is supplied from said pressure chamber into said hydraulic pressure circuit.

12. A hydraulic brake apparatus as set forth in claim 11, wherein said pressure supply means begins to supply the hydraulic pressure from said pressure chamber into said hydraulic pressure circuit, when the hydraulic braking pressure discharged from said master cylinder is equal to or greater than the first predetermined pressure, and said pressure supply means terminates supplying the hydraulic pressure from said pressure chamber into said hydraulic pressure circuit, when the hydraulic braking pressure discharged from said master cylinder and/or the hydraulic pressure in said pressure chamber is equal to or lower than a third predetermined pressure.

13. A hydraulic brake apparatus as set forth in claim 12, wherein the third predetermined pressure is set to be zero.

14. A hydraulic brake apparatus as set forth in claim 11, wherein said pressure supply means begins to supply the hydraulic pressure from said pressure chamber into said hydraulic pressure circuit, when the hydraulic braking pressure discharged from said master cylinder is equal to or greater than the first predetermined pressure, and terminates supplying the hydraulic pressure from said pressure chamber into said hydraulic pressure circuit, when a predetermined time has elapsed from the beginning of supplying the hydraulic pressure from said pressure chamber into said hydraulic pressure circuit.

15. A hydraulic brake apparatus as set forth in claim 11, further comprising pressure detecting means for detecting at least the hydraulic braking pressure discharged from said master cylinder, and wherein said pressure supply means controls the hydraulic pressure in said pressure chamber supplied into said hydraulic pressure circuit, on the basis of the pressure detected by said pressure detecting means.
